(19) United States
(12) Patent Application Publication
(10) Pub. No.: US 2014/0267208 A1
(43) Pub. Date: Sep. 18, 2014

(54) IMAGE DISPLAY DEVICE AND IMAGE DISPLAY METHOD

(71) Applicant: SONY CORPORATION, Tokyo (JP)

(72) Inventors: MASAKAZU YAJIMA, Chiba (JP); YOICHIRO SAKO, Tokyo (JP); TAKAYUKI HIRABAYASHI, Tokyo (JP); AKIRA ONO, Kanagawa (JP); MASASHI TAKEDA, Tokyo (JP)

(73) Assignee: SONY CORPORATION, Tokyo (JP)

(21) Appl. No.: 14/201,422

(22) Filed: Mar. 7, 2014

(30) Foreign Application Priority Data
Mar. 15, 2013 (JP) 2013-053740

(51) Int. Cl. G02B 27/01; G09G 5/00

(52) U.S. Cl. CPC G02B 27/017; G09G 5/00
USPC 345/211

(57) ABSTRACT

An image display device includes an image display unit that displays an image, a mounting unit that is adapted to mount the image display unit on a user's head or face, a power generation element that is attached to one or more installation portions including an outer surface of the image display unit or the mounting unit, and a control unit that performs control based on a power generation amount of the power generation element.

### CROSS REFERENCE TO RELATED APPLICATION(S)

This application claims the benefit of Japanese Priority Patent Application JP 2013-053740 filed Mar. 15, 2013, the entire contents of which are incorporated herein by reference.

### BACKGROUND

The present technology relates to an image display device that is mounted and used on a user's head or face and an image display method, and particularly, to a head- or face-mounted image display device having a power generation function and an image display method.

Small-sized information equipment, such as mobile phones e.g., smart phones, tablet terminals, e-book readers, and handheld music players, that can be carried outdoors and used by a user are in widespread use. Recently, image display devices that are mounted on a head or a face and used to view an image, that is, head-mounted displays, are also widely used.

Head-mounted displays have, for example, image display units disposed for each of right and left eyes, and form an enlarged virtual image of a display image using a virtual image optical system so that a user can observe a realistic image. In addition, when head-mounted displays are configured to completely cut off the outside world when being mounted on a user's head, the immersion feeling is increased during viewing. In addition, head-mounted displays can also project different pictures to right and left eyes, and thus can provide a 3D image when displaying images with the parallax between right and left eyes.

Basically, small-sized information equipment is driven using a power storage element such as a secondary cell as a main power source in consideration of outdoor use under an environment with no power source. In addition, since the operation time of the secondary cell is limited, many users carry a handheld recharger so as to charge the cell anywhere. Recently, handheld power generation devices that obtain electric power anywhere by power generation using environmental energy or the like have been developed. Examples of energy sources in energy harvesting include environmental electromagnetic waves, solar light, vibrations, and heat.

For example, there is a proposal of a mobile phone in which a solar cell is laminated and disposed on a conductive key sheet to compensate for electric power consumption of a secondary cell using a light source and external light (for example, see Japanese Unexamined Patent Application Publication No. 2012-252715).

In the case of a head-mounted display, since it is mounted and used on a user's head or face, a location where a power generation device is installed is restricted from the viewpoint of design. In addition, the user is assumed to move with the head-mounted display mounted, and there is concern, that the power generation amount may be significantly changed according to environmental chances, that is, the power generation device may not stably supply electric power.

### SUMMARY

It is desirable to provide an excellent head- or face-mounted image display device that is provided in consideration of a restriction in design and can perform power generation according to environmental changes, and an excellent image display method.

According to a first embodiment of the present technology, there is provided an image display device including an image display unit that displays an image, a mounting unit that is adapted to mount the image display unit on a user's head or face, a power generation element that is attached to one or more installation portions including an outer surface of the image display unit or the mounting unit, and a control unit that performs control based on a power generation amount of the power generation element.

According to a second embodiment of the present technology, in the image display device according to the first embodiment, the power generation element is at least one of a silicon-based solar cell, a CdTe-based solar cell, a dye-sensitised solar cell, an iron sulfide-based solar cell, an ultraviolet solar cell, an infrared solar cell, an element (radio wave generation (using a distant electromagnetic field)) that induces electric power using at least one of electromagnetic induction and electrostatic induction with radio waves (a distant electromagnetic field) or a near electromagnetic field, power generation using a near electromagnetic field, and a wireless power feeding element (including a magnetic resonance type, an electromagnetic induction type, and an electric field coupling type). In principle, there is no definite difference on the power receiving side between the power generation using an electromagnetic field and the wireless power feeding. Accordingly, in this specification, the wireless power feeding is regarded to be specialized in electric power transmission on the power feeding side. From that viewpoint, in the case of the power generation using an electromagnetic field, electric power is induced using an electromagnetic field formed not to transmit electric power, but formed naturally. In the case of the wireless power feeding, an electromagnetic field intended to feed power is picked up on the power receiving side.

According to a third embodiment of the present technology, in the image display device according to the first embodiment, the image display unit displays the image in a see through manner, and a transparent first power generation element is installed at the center of the outer surface of the image display unit.

According to a fourth embodiment of the present technology, in the image display device according to the third embodiment, a semitransparent second power generation element is installed in a peripheral portion of the outer surface of the image display unit.

According to a fifth embodiment of the present technology, in the image display device according to the fourth embodiment, a flexible third power generation element is installed in an installation portion other than the image display unit.

According to a sixth embodiment of the present technology, in the image display device according to the fifth embodiment, the first power generation element is an ultraviolet or infrared solar cell, the second power generation element is a dye-sensitised solar cell, and the third power generation element, is a silicon-based solar cell.

According to a seventh embodiment of the present technology, in the image display device according to the fifth embodiment, the first power generation element is an ultraviolet or infrared solar cell, the second power generation element, is a rigid dye-sensitised solar cell, and the third power generation element is a flexible dye-sensitised solar cell.

According to an eighth embodiment of the present technology, in the image display device according to the first embodiment, the image display device can be operated in a plurality of operation modes different in power consumption and further includes a plurality of power generation elements employing different power generation methods corresponding to the power consumptions in the respective operation modes.

According to a ninth embodiment of the present technology, in the image display device according to the eighth embodiment, a first power generation element that is used to feed power for a system operation that is operated at all times in all of the operation modes, a second power generation element that is used to feed power for an operation that is operated only in some modes, and a third power generation element that is used to feed power for a clock are provided.

According to a tenth embodiment of the present technology, in the image display device according to the ninth embodiment, the first power generation element is a dye-sensitised solar cell, the second power generation element is a silicon-based solar cell, and the third power generation element is an ultraviolet or infrared solar cell.

According to an eleventh embodiment of the present technology, in the image display device according to the first embodiment, the control unit performs adaptive control to increase or maximize the power generation amount of the power generation element.

According to a twelfth embodiment of the present technology, in the image display device according to the eleventh embodiment, a plurality of power generation elements employing different power generation methods is provided, and the control unit controls impedances of the plurality of power generation elements.

According to a thirteenth embodiment of the present technology, in the image display device according to the twelfth embodiment, the control unit performs maximum power point tracking (MPPT) control so that a current is extracted at an output voltage at which electric power from the plurality of power generation elements reaches a maximum.

According to a fourteenth embodiment, of the present technology, in the image display device according to the eleventh embodiment, a power generation element that performs power generation using electromagnetic waves is provided, the image display device further includes an actuator that changes a posture of the power generation element or an energy transfer mechanism such as a waveguide or an antenna that is equipped in the power generation element to contribute to an increase of the power generation amount, and the control unit controls the posture of the power generation element or the energy transfer mechanism using the actuator so that the power generation amount becomes typically maximum with respect to an incidence angle of electromagnetic waves.

According to a fifteenth embodiment of the present technology, in the image display device according to the eleventh embodiment, the image display device can be operated in a plurality of operation modes different in power consumption, and the control unit switches the operation mode of the image display device according to the power generation amount of the power generation element.

According to a sixteenth embodiment of the present technology, in the image display device according to the eleventh embodiment, a plurality of power generation elements employing different power generation methods is provided, and the control unit feeds power by switching the power generation element according to a change in the power generation amount.

According to a seventeenth embodiment of the present technology, in the image display device according to the eleventh embodiment, the control unit performs guidance into a user's action in which the power generation amount of the power generation element is increased or maximized.

According to an eighteenth embodiment of the present technology, in the image display device according to the seventeenth embodiment, the control unit allows an image showing a user's movement direction for increasing or maximizing the power generation amount of the power generation element to be displayed on the image display unit.

According to a nineteenth embodiment of the present technology, in the image display device according to eleventh embodiment, a power generation element that performs power generation using electromagnetic waves of a specific frequency is provided, the image display device further includes a frequency conversion unit that converts the frequency of the electromagnetic waves arriving at the power generation element, and the control unit controls the conversion of the frequency by the frequency conversion unit to increase or maximize the power generation amount of the power generation element.

According to a twentieth embodiment of the present technology, in the image display device according to the eleventh embodiment, a plurality of power generation elements employing different power generation methods is replaceably installed in one installation portion.

According to a 21st embodiment of the present technology, in the image display device according to the eleventh embodiment, a plurality of power generation elements employing different power generation methods is detachably installed in a superimposed manner in one installation portion.

According to a 22nd embodiment of the present technology, the image display device according to the first embodiment further includes a power generation element that performs power generation using display light of the image display unit.

According to a 23rd embodiment of the present technology, in the image display device according to the 22nd embodiment, the image display unit includes a light guide plate that propagates the display light and a polarizing filter that reflects the display light inside the light guide plate, and the power generation element is inserted in the polarizing filter.

According to a 24th embodiment of the present technology, in the image display device according to the 22nd embodiment, the image display unit includes a color filter that colorizes a display image or improves color purity, and the power generation element is inserted in the color filter.

According to a 25th embodiment of the present technology, in the image display device according to the 22nd embodiment, the image display unit includes a power generation element doubling as a color filter that colorizes a display image or improves color purity.

According to a 26th embodiment of the present technology, in the image display device according to the first embodiment, the control unit performs sensing based on the output of the power generation element.

According to a 27th embodiment of the present technology, in the image display device according to the first embodiment, the power generation element is formed of a photocell having a sensitivity to visible light and infrared side, and the control unit performs motion sensing based on the output on the infrared side of the power generation element.

According to a 28th embodiment of the present technology, there is provided an image display method including detecting a power generation amount of a power generation element, that is installed in at least one of an image display unit or a mounting unit that is adapted to mount the image display unit on a user's head or face, and controlling the image display device provided with the image display unit, based on the power generation amount.

According to an embodiment of the present technology, it is possible to provide an excellent head- or face-mounted image display device that is provided in consideration of a restriction in design and can perform power generation according to environmental changes, and an excellent image display method.

In the image display device according to an embodiment of the present technology, a transparent power generation element can be applied to increase a degree of freedom of an installation area of the power generation element while keeping the design. The transparent power generation element has colorability and can be formed in a free shape. Thus, even when it is disposed on a part or the whole of a surface of the main body of the image display device, there is no damage on design.

In addition, the image display device according to an embodiment of the present technology can respond to an increase or decrease in the power generation amount according to environmental changes, since the power generation element and the image display device are controlled so that the power generation amount is increased according to changes in the power generation environment.

Other objects, features, and advantages of the present technology will be apparent using more detailed description based on embodiments, which will be described later, or the accompanying drawings.

### BRIEF DESCRIPTION OF THE DRAWINGS

FIG. 1 is a diagram showing a user on which a transmission-type head-mounted image display device is mounted, as viewed from the front;

FIG. 2 is a diagram showing the user on which the image display device Shown in FIG. 1 is mounted, as viewed from above;

FIG. 3 is a diagram showing a user on which a light blocking-type head-mounted image display device is mounted, as viewed from the front;

FIG. 4 is a diagram showing the user on which the image display device shown in FIG. 3 is mounted, as viewed from above;

FIG. 5 is a diagram showing an example of a functional configuration mainly for realizing a display function of the image display device;

FIG. 6 is a diagram illustrating locations where power generation elements are installed in the image display devices;

FIG. 7 is a diagram illustrating the transitions of power generation amounts of an infrared power generation element, an ultraviolet power generation element, a silicon-based solar cell, a dye-sensitised solar cell, and a radio wave generator according to time;

FIG. 8 is a diagram illustrating a functional configuration of an electric power system of the image display device;

FIG. 9 is a diagram showing an example of the arrangement of the power generation elements in the transmission-type head-mounted image display device;

FIG. 10 is a diagram illustrating a power generation environment of the image display device;

FIG. 11 is a diagram showing an example in which a main power source of the image display device is divided into a plurality of systems and a power generation element employing a different power generation method is disposed for each system;

FIG. 12 is a diagram showing that a posture of a power generation element installed in the image display device is changed by following the movement of the sun;

FIG. 13 is a diagram showing an example of a configuration of the image display device in which a plurality of power generation elements employing different power generation methods is installed;

FIG. 14 is a flowchart showing processing procedures for switching of an operation mode by the control unit according to the power generation environment and the power generation situation;

FIG. 15 is a flowchart, showing processing procedures for switching of the power generation element that is used as a main power source by a power management unit according to changes of the power generation environment;

FIG. 16 is a diagram schematically showing a functional configuration adapted to control a user's action by the image display device;

FIG. 17 is a diagram showing that guidance information is displayed in a superimposed manner on an image of a visual field of a user that is displayed in a see through manner;

FIG. 18 is a diagram illustrating a functional configuration of an electric power system of the image display device adopting absorption frequency shift; and

FIG. 19 is a diagram schematically showing a cross-section structure of a display panel provided with a power generation element.

### DETAILED DESCRIPTION OF EMBODIMENTS

Hereinafter, embodiments of the present technology will be described in detail with reference to the drawings.

### A. Configuration of Device

FIG. 1 shows an appearance configuration of an image display device 100 according to an embodiment of the present technology. The image display device 100 is mounted and used on a user's head or face to display an image for each of right and left eyes. The image display device 100 shown in FIG. 1 is a transmission type, that is, a see through type, and a user can view a landscape of the real world over an image (that is, in a see through manner) even during the display of the image. Accordingly, it is possible to show a virtual display image such as an AR image in a superimposed manner on the landscape of the real world (for example, see Japanese Unexamined Patent Application Publication No, 2011-2753). Since the display image is not shown from the outside (that is, to other people), privacy is easily attained during the display of information.

In a main body of the image display device 100 shown in FIG. 1, virtual image optical units 101L and 101R, each formed of a transparent light guide unit, are positioned to be opposed to right and left eyes of a user, respectively, and images (not shown) to be observed by the user are displayed inside the virtual image optical units 101L and 101R.

The virtual image optical units 101L and 101R are supported by a support 102. An external camera 512 for input of a surrounding image (a visual field of the user) is installed at approximately the center of the support 102. The external camera 512 can capture an image of, for example, a landscape in a user's line-of-sight direction. It is more preferable that the external camera 512 be configured to include a plurality of cameras so as to acquire three-dimensional information of the surrounding image using parallax information.

Microphones 103L and 103R are installed adjacent to both right and left ends of the support 102. The microphones 103L and 103R are provided approximately symmetric with respect, to each other, and thus only a voice (a voice of the user) localized to the center is recognized and can thus be separated from surrounding noise and speaking voices of other people, whereby, for example, it is possible to prevent a malfunction during operation by voice input.

FIG. 2 shows the image display device 100 mounted on the user, as viewed from above. As shown in FIG. 2, display panels 104L and 104R that display images for a left eye and a right eye, respectively, are disposed at both right and left ends of the image display device 100. Each of the display panels 104L and 104R is formed of a microdisplay such as a liquid crystal display or an organic EL element, or a laser scanning display such as a retina direct drawing display. The microdisplay such as an organic EL element uses a color filter for colorization or for improving color purity. Right and left display images that are output from the display panels 104L and 104R are propagated up to the vicinities of the right and left, eyes by the virtual image optical units 101L and 101R, and their enlarged virtual images are formed on the pupils of the user.

Although not shown in detail in FIG. 2, each of the virtual image optical units 101L and 101R includes an optical system that collects the light irradiated from the microdisplay, a light guide plate that is disposed at a position where the light passing through the optical system enters, a polarizing filter that reflects the light incident on the light guide plate, and a polarizing filter that allows the light fully reflected and propagated inside the light guide plate to be emitted toward the eyes of the user (for example, see Japanese Unexamined Patent Application Publication. No. 2009-36955).

FIGS. 1 and 2 briefly show the appearance shape of the image display device 100. Power generation elements using light including solar light are installed in a plurality of installation portions including an outer surface of the main body of the image display device 100, and the structure thereof will be described later.

FIG. 3 shows an appearance configuration, of an image display device 300 according to another embodiment of the present technology. The image display device 300 is mounted and used on a user's head or face, and display panels (not shown in FIG. 3) to be observed by the user are positioned to be opposed to the right and left eyes, respectively, inside of the main body. The display panel is configured to include a microdisplay such as an organic EL element or a liquid crystal display, or a laser scanning display such as a retina direct drawing display. The microdisplay such as an organic EL element uses a color filter for colorization or for improving color purity (the same as above). The image display device 300 is a light blocking type and directly covers eyes of the user when being mounted on the head, and thus it is possible to impart an immersion feeling to the user during viewing of an image.

Differently from the see through type, the user on which the image display device 300 is mounted may not directly view a landscape of the real world. However, the image display device 300 is provided with an external camera 512 that captures an image of a landscape in a user's line-of-sight, direction to display the captured image, and thus the user can view the landscape of the real world indirectly (that is, in a video see through manner). On the video see through image, a virtual display image such as an AR image can be shown in a superimposed manner. Since the display image is not shown from the outside (that is, to other people), privacy is easily attained during the display of information.

An external camera 512 for input of a surrounding image (a visual field of the user) is installed at approximately the center of the front surface of the main body of the image display device 300. Microphones 303L and 303R are installed adjacent to both right and left ends of the main body of the image display device 300, respectively. The microphones 303L and 303R are provided approximately symmetric with respect to each other, and thus only a voice (a voice of the user) localized to the center is recognized and can thus be separated from surrounding noise and speaking voices of other people, whereby, for example, it is possible to prevent a malfunction during operation by voice input.

FIG. 4 shows the user on which image display device 300 shown in FIG. 3 is mounted, as viewed from above. The image display device 300 shown in FIG. 4 has display panels 304L and 304R for a left eye and a right eye in a side surface opposed to the face of the user. Each of the display panels 304L and 304R is configured to include, for example, a microdisplay such as an organic EL element or a liquid crystal display, or a laser scanning display such as a retina direct drawing display. Display images of the display panels 304L and 304R are observed by the user as enlarged virtual images by passing through virtual image optical units 301L and 301R. Although not shown in detail in FIG. 4, the virtual image optical units 301L and 301R include one or more optical lenses to enlarge and project the display images of the display panels 304L and 304R at a predetermined wide viewing angle.

In addition, since the eye height and the interpupillary distance vary between users, it is necessary to match the right and left display systems and the eyes of the user on which the image display device 300 is mounted. In the example shown in FIG. 4, an interpupillary distance adjuster 305 is provided between the display panel for a right eye and the display panel for a left eye.

FIGS. 3 and 4 briefly show the appearance shape of the image display device 300. Power generation elements using light including solar light are installed in a plurality of installation portions including an outer surface of the main body of the image display device 300, and the structure thereof will be described later.

FIG. 5 shows an example of a functional configuration mainly for realizing a display function of the image display device 100. It is understood that the other image display device 300 also has the same internal configuration. However, a functional configuration of an electric power system of the image display device 100 will not be shown in FIG. 5. The functional configuration of the electric power system will be described later. Hereinafter, respective units shown in FIG. 5 will be described.

A control unit 501 is provided with a read only memory (ROM) 501A and a random access memory (RAM) 501B. Program codes that are executed by the control unit 501 and various data are stored in the ROM 501A. The control unit 501 executes a program loaded to the RAM 501B to start control of image display and to control, the overall operation of the image display device 100 in a generalized manner. Examples citric programs and data stored in the ROM 501A include image display control programs, programs for communication processing with an external machine such as a server (not shown) on the internet, power generation control programs for control of the overall operation of the image display device 100 according to the power generation environment and the power generation situation of a power generation element (to be described later), and unique identification information of the device 100.

An input operation unit 502 is provided with one or more operators such as a key, a button, and a switch that are used for an input operation of the user, receives a user's instruction via the operator, and outputs the instruction to the control unit 501. The input operation unit 502 receives, in the same manner, a user's instruction that is formed of a remote control command received by a remote control reception unit 503 and outputs the instruction to the control unit 501.

A posture/position, detection unit 504 is a unit that detects a posture and a position of the head of the user on which the image display device 100 is mounted. The posture/position detection unit 504 is configured to include any one of a gyro sensor, an acceleration sensor, a global positioning system (GPS) sensor, a geomagnetic sensor, a Doppler sensor, an infrared sensor, a radio wave intensity sensor, and the like, or a combination of two or more sensors in consideration of advantages and disadvantages of the sensors.

A state detection unit 511 acquires state information related to a state of the user on which the image display device 100 is mounted, and outputs the state information to the control unit 501. As the state information, a working state of the user (whether the image display device 100 is mounted or not), an action state of the user (a moving state such as standing still, walking, and running, an open/closed state of eyelids, a direction of eyes, and a pupil size), a mental state (an impression degree, an excitation degree, an awakening degree, feelings, emotions, and the like related to whether the user is preoccupied or concentrating during observation of a display image), and a physiological state are acquired. In order to acquire the state information from the user, the state detection unit 511 may be provided with various state sensors and timers (not shown) such as a mounting sensor formed of a mechanical switch, an internal camera that captures an image of the face of the user, a gyro sensor, an acceleration sensor, a speed sensor, a pressure sensor, a body temperature sensor, a sweating sensor, a myoelectric potential sensor, an ocular potential sensor, a brain wave sensor, an exhalation sensor, and a gas ion concentration sensor.

An environmental sensor 516 is formed of various sensors that measure information related to the surrounding environment of the image display device 100, such as a power generation environment. For example, the environmental sensor 516 includes an electromagnetic wave sensor, a light sensor, and the like to obtain power generation efficiency and the like of a power generation element (to be described later) that performs power generation using light including solar light.

The external camera 512 is disposed, for example, at approximately the center of the front surface of the main body of the image display device 100 (see FIG. 1) to capture a surrounding image. In addition, the external camera 512 is controlled in pan, tilt, and posture in a roll direction in accordance with the user's line-of-sight direction detected by the state detection unit 511, and thus an image in the user's own line-of-sight direction, that is, an image in the user's line-of-sight direction can be captured by the external camera 512. It is more preferable that the external camera 512 be configured to include a plurality of cameras so as to acquire three-dimensional information of the surrounding image using parallax information. The user can adjust the zoom of the external camera 512 through the operation of the input operation unit 502 and the input of a voice or a pupil size recognized by the internal camera. The image captured by the external camera 512 can be displayed on a display unit 509 and can also be stored in a storage unit 506.

A communication unit 505 performs a communication process with an external machine such as a server (not shown) on the internet, a process of subjecting a communication signal to modulation or demodulation, and a process of subjecting a communication signal to encoding or decoding. The control unit 501 sends data to be transmitted to the external machine from the communication unit 505.

The communication unit 505 has an arbitrary configuration. For example, the communication unit 505 can be configured in accordance with a communication method that is used in the transmission and reception to and from the external machine serving as a communication partner. The communication method may employ either wired or wireless form. Examples of the communication standard mentioned herein include mobile high-definition link (MHL), universal serial bus (USB), high definition multimedia interface (HDMI), Wi-Fi (registered trade name), Bluetooth (registered trade name) communication, Bluetooth (registered trade name) low energy (BLE) communication, ultralow power consumption wireless communication such as ANT, and infrared communication. Otherwise, the communication unit 505 may also be a cellular wireless transceiver that is operated according to standards such as wideband code division multiple access (W-CDMA) and long term evolution (LTE).

The storage unit 506 is a mass-storage device formed of a solid state drive (SSD) or the like. The storage unit 506 stores application programs that are executed by the control unit 501 and various data. Examples of the stored data include information such as a power generation amount of a power generation element (to be described later), display images of the process results of the power generation amount, and data acquired from a network via the communication unit 505.

An image processing unit 507 subjects an image signal output from the control unit 501 to a further signal process such as image quality correction, and performs conversion to a resolution according to the screen of the display unit 509. A display drive unit 508 sequentially selects pixels of the display unit 509 for each line and performs line sequential scanning to supply a pixel signal based on the image signal subjected to the signal process.

The display unit 509 has a display panel configured to include a microdisplay such as an organic electro-luminescence (EL) element or a liquid crystal display, or a laser scanning display such as a retina direct drawing display (corresponding to the display panels 104L and 104R in FIG. 2, or the display panels 304L and 304R in FIG. 4).

A virtual image optical unit 510 enlarges and projects the display image of the display unit 509 so that the user observes the display image as an enlarged virtual image.

A voice processing unit 513 subjects a voice signal output from the control unit 501 to sound quality correction or voice amplification and performs a further signal process of the input voice signal. A voice input/output unit 514 performs external output of the voice after the voice process and performs voice input from the microphone (described above).

### B. Power Generation System of Image Display Device

The image display devices 100 and 300 are provided with, for example, a power generation element as a main power source or an auxiliary power source for recharging of a secondary cell. In this embodiment, a power generation element that performs power generation using environmental energy, such as a power generation element using light including solar light or a power generation element using environmental electromagnetic waves, is used.

Basically, the power generation element that performs power generation using environmental energy is preferably installed on the outer surface of the main body of the device to be exposed to the outside world. In the case of a power generation element using light including solar light, the power generation efficiency is increased by applying sunlight or illumination light, and in the case of a power generation element using electromagnetic waves, the power generation efficiency is increased by exposure to electromagnetic waves.

FIGS. 1 to 4 briefly show the appearances of the transmission-type image display device 100 and the immersion-type image display device 300. FIG. 6 illustrates locations where the power generation elements are installed when the main bodies of the image display devices 100 and 300 have a structural body formed of a tubular frame 630 that is supported and fixed to the user's head. The frame 630 is classified as a front surface frame 631 in which the display unit 509 is supported by a front surface of the user's head (that is, on the face side), a side surface frame 632, and a rear surface frame 633 (in FIG. 6, expressed by the dotted line). Examples of candidates of the location where the power generation element is installed include a total of fifteen locations including a display unit front surface 601, a side surface frame upper portion 602, a side surface frame lower portion 603, a side surface frame left portion 604, a side surface frame right portion 605, a side surface frame center 606, a front surface frame upper portion 607, a front surface frame lower portion 608, a front surface frame left portion 609, a front surface frame right portion 610, a rear surface frame upper portion 611, a rear surface frame lower portion 612, a rear surface frame left portion 613, a rear surface frame right portion 614, and a rear surface frame center 615.

Since the image display device 100 or 300 is mounted and used on the user's head and is exposed to the eyes in the surroundings, it is a product of which both functionality and good design are regarded as important. Accordingly, it is desirable that power generation elements be disposed in the respective installation portions 601 to 615 to increase the power generation efficiency and not to damage the design. A method of arranging the power generation elements without damage on design will be described later in detail.

Specific examples of the power generation element of the image display devices 100 and 300 are as follows:

(1) Silicon-based solar cells made using crystalline silicon (including monocrystal, polycrystal, microcrystal, and amorphous silicons)

(2) Compound-based solar cells such as CdTe-based solar cells

(3) Solar cells made using an organic compound such as dye-sensitised solar cells

(4) Iron sulfide-based solar cells

(5) Ultraviolet solar cells that perform power generation using ultraviolet rays while allowing visible light to be transmitted therethrough

(6) Infrared solar cells that perform, power generation using infrared rays

(7) Radio wave generators (rectennas) that induce electric power to a power generation element using radio waves (distant electromagnetic field)

(8) Power generation using a near electromagnetic field to induce electric power to an element using the electromagnetic field in a neighboring region including electromagnetic induction and electrostatic induction

(9) Wireless power feeding using magnetic resonance, electromagnetic induction, and electric field coupling

In principle, there is no definite difference on the power receiving side between the power generation using an electromagnetic field and the wireless power feeding. Accordingly, in this specification, the wireless power feeding is regarded to be specialized in electric power transmission on the power feeding side. From that viewpoint, in the case of the power generation using an electromagnetic field, electric power is induced using an electromagnetic field formed not to transmit electric power, but formed naturally. In the case of the wireless power feeding, an electromagnetic field intended to feed power is picked up on the power receiving side.

Since the power generation, elements (1) to (9) have different device characteristics and the like, these are different in their power generation methods or power generation principles, including wavelength components of electromagnetic waves that are used in the power generation.

Even when the foregoing cells are the same solar cells, the ultraviolet cell can perform superior power generation using ultraviolet light, the infrared cells can perform superior power generation using infrared light, the dye-sensitised solar cells can perform superior power generation using indoor light, and the silicon-based solar cells can perform superior power generation using outdoor light (solar light). Among the solar cells, the silicon-based solar cells and the dye-sensitised solar cells obtain a large power generation amount.

The above-exemplified power generation elements (1) to (9) are influenced differently by the power generation environment, and their merits in power generation amount are reversed according to the power generation environment. For example, the power generation amount of a solar cell is large in the daytime, but is reduced after sunset, but a power generation element using electromagnetic waves can obtain an approximately constant power generation amount at any time of night or day. In addition, among the solar cells, the dye-sensitised solar cells and the silicon-based solar cells using visible light obtain a large power generation amount, but the solar cells using only a specific wavelength component (invisible component), such as the ultraviolet solar cells and the infrared solar cells, obtain a small power generation amount. In general, the dye-sensitised solar cells perform superior power generation using indoor light and the silicon-based solar cells perform superior power generation using outdoor light. The light intensity of each wavelength component varies according to the power generation environment (weather, time, period (season), location, and light source), and thus the merits of the various solar cells also vary.

FIG. 7 illustrates the transitions of the power generation amounts of an infrared solar cell, an ultraviolet solar cell, a silicon-based solar cell, a dye-sensitised solar cell, and a radio wave generator according to time FIG. 7 shows the power generation amounts of the generators of the respective power generation methods based on the assumption of a power generation environment including location: indoor location, light source: indoor light, weather: no regard is given, period: all year round, and time: daytime. The graphs shown in FIG. 7 show the power generation amounts in a radial direction, and show a time in a circumferential direction. The power generation amounts in the radial direction are normalized and displayed based on the fact that a predetermined maximum power generation amount is 10.

The radio wave generator uses, as an electric power source, radiation electromagnetic waves from a mobile phone base station or an access point of a wireless local area network (LAN), for example, and the one-day power generation amount thereof is stable regardless of the presence of sunlight or interior lighting. Accordingly, the radio wave generator is higher in the power generation amount than all other types of power generation elements during the night from sunset to sunrise.

The power generation amounts of the solar cells are rapidly increased after the time of sunrise (7 a.m. in the example shown in FIG. 7). However, since the infrared power generation element and the ultraviolet power generation element only use light having a specific wavelength component, regardless of whether the light is indoor light or outdoor light, the power generation amount is relatively low. Since the example shown in FIG. 7 is based on the assumption of a user who mainly works indoors, the power generation amount of the dye-sensitised solar cell is greater than that of the silicon-based solar cell during the day. However, when the user goes out or moves to an indoor location where the sunlight reaches, the power generation amount of the silicon-based solar cell is temporarily greater than that of the dye-sensitised solar cell. In addition, since the interior lighting becomes a main light source from the time of sunset (6 p.m. in the example shown in FIG. 7) to the time for lights out and bedtime (12 a.m. in the example shown in FIG. 7), the power generation amounts of the silicon-based solar cell and the ultraviolet power generation element are reduced, and thus the power generation amount of the infrared power generation element becomes greater than or comparable with the foregoing power generation amounts.

In the example shown in FIG. 7, the one-day power generation time (a time during which the power generation amount is greater than a threshold (for example, a system operation level)) is long in order of dye-sensitised solar cell>silicon-based solar cell>infrared solar cell>ultraviolet solar cell. In addition, the one-day power generation amount (integrated electric power amount [J, Wh]) is large in order of silicon-based solar cell>dye-sensitised solar cell>infrared solar cell>ultraviolet solar cell. When comparing the silicon-based solar cell and the dye-sensitised solar cell, it is found that in the former case, the average power generation amount is large and a variation in power generation amount is also large, and in the latter case, the average power generation amount is small and a variation in power generation amount, is also small.

It is preferable that a power generation element employing a power generation method appropriate for the user's use environment (that is, the power generation environment of a location where the user uses the image display device 100) be used in the image display device 100 or 300. Otherwise, the image display device 100 or 300 may be provided with a plurality of kinds of power generation elements so as to switch to an appropriate power generation system according to the power generation environment and the power generation situation.

Other than the power generation environment such as the intensity of the electromagnetic wave and the power generation situation such as the power generation amount, there are also factors that determine the merits of the various solar cells. Since the ultraviolet solar cell and the infrared solar cell can realize a structure that transmits visible light, the cells have an advantage in that the visual field is not blocked (that is, the power generation can be performed even in a see through mode). In addition, the ultraviolet solar cell can perform the power generation while blocking ultraviolet rays having an influence on the health of the user.

Even when the foregoing cells are the same solar cells, the ultraviolet cell can perform superior power generation using ultraviolet light, the infrared cell can perform superior power generation using infrared light, the dye-sensitised solar cell can perform superior power generation using indoor light, and the silicon-based solar cell can perform superior power generation using outdoor light (solar light) (described above). Accordingly, as shown in FIG. 7, the merits in power generation amount of the respective types of cells vary according to the power generation environment such as the installation location, the light source being used, weather, season, and a period of time in a single day, and the merits of the power generation elements are not determined only with the power generation amount. For example, when a solar cell is installed in the transmission-type image display device 100, a semitransparent power generation element such as a dye-sensitised solar cell or a transparent antenna is preferably used in the display unit front surface 601 in consideration of visibility to perform the power generation. Otherwise, an ultraviolet power generation element may be used to perform the power generation so that the user's face is not exposed to ultraviolet rays via the transparent display unit front surface 601.

FIG. 8 illustrates the functional configuration of the electric power system of the image display device 100. The other image display device 300 may also use an electric power system having the same functional configuration as that of FIG. 8.

The image display device 100 shown in FIG. 8 has an electric power system including a power generation element unit 810, a power storage unit 820, and a power management unit 830. The display system formed of the control unit 501 and the display unit 509 can be driven with electric power that is supplied from the electric power system.

The power generation element unit 810 performs power generation using environmental energy such as visible light, infrared light, ultraviolet light, and electromagnetic waves, or induces a current or a voltage. The power generation element unit 810 may be provided with a plurality of kinds of power generation elements 811-1, 811-2, 811-3, . . . employing different power generation methods, such as a silicon-based solar cell, a dye-sensitised solar cell, an infrared power generation element, an ultraviolet power generation element, a radio wave generator, and power generation using a near electromagnetic field, or may be configured to include only one kind of power generation element.

An actuator 812 is attached to the power generation element unit 810. By changing the whole power generation element unit 810 or some of the power generation elements 811-1, 811-2, 811-3, . . . included in the power generation element unit 810 in posture or position (waveguide), the actuator 812 can provide a posture changed so that environmental energy, such as visible light, infrared light, ultraviolet light, and electromagnetic waves, that is used in the power generation is easily received (that is, a situation in which the power generation is easily performed).

The power storage unit 820 stores the electric power generated by the power generation element unit 810 or the induced current or voltage in a power storage element 824.

A switching unit 821 determines a power generation element that is to be used for power storage, that is, performs switching of the power generation system when the plurality of kinds of power generation elements 811-1, 811-2, 811-3, . . . employing different power generation methods are used as the power generation element unit 810. However, when a power generation element of a single power generation method is used, the switching unit 821 can be omitted.

A rectification circuit unit 822 rectifies the current supplied from the power generation element unit 810 via, the switching unit 821. A regulator 823 performs a step-up or -down operation so that the voltage after the rectification changes to a level appropriate for power storage. The obtained DC voltage is supplied to and stored in the power storage element 824. The power storage element 824 is formed of, for example, a capacitor, a secondary cell, a mechanism (a spiral spring, a spring, or the like) that stores energy as kinetic energy, a mechanism (a heat storage material) that stores energy as thermal energy, or the like, and stores the electric power obtained through the power generation of the power generation unit or accumulates the electric power as energy.

The power management unit 830 distributes the electric power supplied from the power storage element 824 via a predetermined power transmission path to the respective circuit components such as the control unit 501 and the display unit 509 in the image display device 100. The power management unit 830 monitors the power generation situation in the electric power system, such as the power generation amount in the power generation element unit 810 and the power storage amount of the power storage element 824, to report the results of the monitoring to the control unit 501. The power management unit 830 can receive a report on the power generation environment of the image display device 100 from the control unit 501.

In this embodiment, the power management unit 830 performs adaptive control, of the power generation operation, such as control of the impedance of the power generation element unit 810 or the power storage unit 820, control of a switching operation of the power generation system (a switching operation that is performed by the switching unit 821), control of the posture of the power generation element unit 810 (control of the driving of the actuator 812), absorption frequency shift (in the case in which photovoltaic power generation is performed in the power generation element unit 810), and waveguide control, according to the power generation environment and the power generation situation of the image display device 100. The adaptive control will be described later in detail.

Regarding the operation of the main body of the image display device 100 having the display system including the control unit 501 and the display unit 509, a plurality or modes different in power consumption is defined is defined as follows:

(a) An active mode for operating almost all functions

(b) A first energy saving mode for a low-clock operation and for reducing the luminance of the display unit 509

(c) A second energy saving mode for intermittent driving

(d) A sleep mode for stopping operations of some functions

(e) A deep sleep mode for stopping operations of larger number of functions

(f) A stop mode for completely stopping the operation

Basically, it is assumed that among the operation modes, in the active mode (a) and the first energy saving mode (b), the image display device 100 consumes the electric power at all times. In addition, it is assumed that in the second energy saving mode (c), the operation is performed intermittently, and instantaneous power is equal to or greater than in the active mode (a) and the first energy saving mode (b) although the electric power is not consumed at all times.

In this embodiment, according to the power generation environment, the power generation situation reported from the power management unit 830, and the like, the control unit 501 controls switching of the operation mode (described above) of the display system, and controls a user's action to guide the user into a better power generation environment or power generation situation. The adaptive control will be described later in detail.

In addition, the control unit 501 can determine the current power generation environment of the image display device 100 using information input from, for example, the environmental sensor 516, the posture/position detection unit 504, the state detection unit 511, the external camera 512, and the like. The control unit 501 reports the determined power generation environment to the power management unit 830.

### First Embodiment

First, a method of arranging the power generation elements without damage on design will be described as a first embodiment.

FIG. 9 shows an example of the arrangement of the power generation elements in the transmission-type head-mounted image display device 100. Basically, in the example shown in FIG. 9, the power generation elements can be attached over the whole outer surface of the image display device 100. However, a plurality of kinds of power generation elements employing different power generation methods is used in consideration of not damaging the function of the image display device 100, that is, light transmission, and the design of the main body of the device 100, and of securing the power generation efficiency.

As a first power generation element 901, an ultraviolet solar cell or an infrared solar cell is disposed to transmit visible light therethrough and to perform the power generation using invisible light such as ultraviolet rays or infrared rays in a central portion of the display unit front surface 601, so as to perform the power generation without blocking the visual field of the user on which the image display device 100 is mounted.

In addition, as a second power generation element 902, a dye-sensitized solar cell is disposed in a peripheral portion of the display unit front surface 601. Since the peripheral portion of the display unit front surface 601 is near a visible critical range of the user, it does not have to have high transparency. When a semitransparent power generation element such as a dye-sensitized solar cell is disposed in this peripheral portion, the visual field of the user is slightly reduced and object recognition accuracy is thus slightly reduced, but the power generation amount can be improved.

Furthermore, as a third power generation element 903, a silicon-based solar cell is disposed in other installation portions 602 to 615. Since these portions do not have to have a curved surface and light transmission, a flexible-type silicon-based solar cell is used so as not to damage the original shape, that is, the design of the main body of the image display device 100. In addition, the third power generation element 903 may be installed on the surfaces of the installation portions 602 to 615, or may be installed on micropores formed on the surfaces of the installation portions 602 to 615. The surface of the installed third power generation element 903 may be covered with a material having such a thickness that light with which a necessary and sufficient power generation amount can be obtained with respect to the absorption wavelength of the silicon-based solar cell is transmitted therethrough.

### Second Embodiment

Next, a method of arranging the power generation elements according to the intended use will be described as a second embodiment.

Even when the foregoing cells are the same solar cells, the ultraviolet cell can perform superior power generation using ultraviolet light, the infrared cell can perform superior power generation using infrared light, the dye-sensitised solar cell can perform superior power generation using indoor light, and the silicon-based solar cell can perform superior power generation using outdoor light (solar light). Accordingly, as shown in FIG. 7, the merits in power generation amount of the power generation elements of the respective power generation methods vary according to the power generation environment such as the installation location, the light source being used, weather, season, and a period of time in a single day (described above). That is, the power generation elements of the respective power generation methods are different in one-day power generation time (a time during which the power generation amount is greater than a threshold (for example, a system operation level)) and in one-day power generation amount (integrated electric power amount [J, Wh]) according to the power generation environment.

Accordingly, in consideration of the power generation efficiency under the power generation environment that is assumed in the use case of the image display device 100, it is necessary to determine the installation portions of the power generation elements (1) to (9) among the display unit front surface 601, the side surface frame upper portion 602, the side surface frame lower portion 603, the side surface frame left portion 604, the side surface frame right portion 605, the side surface frame center 606, the front surface frame upper portion 607, the front surface frame lower portion 608, the front surface frame left portion 609, the front surface frame right portion 610, the rear surface frame upper portion 611, the rear surface frame lower portion 612, the rear surface frame left portion 613, the rear surface frame right portion 614, and the rear surface frame center 615 (that is, combinations of the installation locations and the power generation elements).

For example, a case is considered in which the image display device 100 is used in a scene including location: indoor location, light source: indoor light, weather: no regard is given, per all year round, and time: daytime. Under such a power generation environment, the power generation time is long in order of dye-sensitised solar cell>silicon-based solar cell>infrared solar cell>ultraviolet solar cell. FIG. 10 schematically shows a power generation environment in the above-described scene. As shown in FIG. 10, indoor light is provided as a main light source that irradiates the image display device 100 with light. In addition, it is considered that approximately 80% of outdoor ultraviolet rays passes through a glass window in the indoor location, is reflected or scattered in the air even in the indoor location, and is thus irradiated onto the whole image display device 100. In addition, it is considered that a fluorescent lamp is a lamp in which a fluorescent substance absorbs ultraviolet rays generated in a fluorescent tube and performs conversion into visible rays, and emits few ultraviolet rays.

When the image display device 100 is used by being operated, under such a power generation environment, not in the second energy saving mode (c) with high instantaneous power, but in the active mode (a) or the first energy saving mode (b) in which the electric power is consumed at all times, a rigid ultraviolet solar cell or infrared solar cell is disposed as a first power generation element 1001 in the central portion of the display unit front surface 601 to secure the visual field of the user. A rigid dye-sensitised solar cell is installed as a second power generation element 1002 in the peripheral portion of the display unit front surface 601.

In addition, as a third power generation element 1003, a flexible dye-sensitised solar cell is installed in nine installation portions including the side surface frame upper portion 602, the side surface frame lower portion 603, the side surface frame left portion 604, the side surface frame right portion 605, the side surface frame center 606, the front surface frame upper portion 607, the front surface frame lower portion 608, the front surface frame left portion 609, and the front surface frame right portion 610, or in fourteen installation portions including the side surface frame upper portion 602, the side surface frame lower portion 603, the side surface frame left portion 604, the side surface frame right portion 605, the side surface frame center 606, the front surface frame upper portion 607, the front surface frame lower portion 608, the front surface frame left portion 609, the front surface frame right portion 610, the rear surface frame upper portion 611, the rear surface frame lower portion 612, the rear surface frame left portion 613, the rear surface frame right portion 614, and the rear surface frame center 615.

### Third Embodiment

Next, a method of dividing the main power source of the image display device 100 into a plurality of systems according to the system operation to arrange a power generation element employing a different power generation method for each system according to the system operation will be described as a third embodiment.

Based on the assumption of a power generation environment including location: indoor location, light source: indoor light, weather: no regard is given, period: all year round, and time: daytime, the one-day power generation time (a time during which the power generation amount is greater than a threshold (for example, a system operation level)) is long in order of dye-sensitised solar cell>silicon-based solar cell>infrared solar cell>ultraviolet solar cell. In addition, the one-day power generation amount (integrated electric power amount [J, Wh]) is large in order of silicon-based solar cell>dye-sensitised solar cell>infrared solar cell>ultraviolet solar cell (described above, see FIG. 7). When comparing the silicon-based solar cell and the dye-sensitised solar cell, the average power generation amount is large and a variation in power generation amount is also large in the former case, and in the latter case, the average power generation amount is small and a variation in power generation amount is also small.

Among the operation modes (a) to (f) of the image display device 100, in the operation modes (a) to (d), a system operation intended to be operated at all times is performed in common. The electric power for the system operation intended to be operated at all times is preferably supplied from a dye-sensitised solar cell having a small variation in power generation amount from the viewpoint of stabilization of the system. Accordingly, a rigid ultraviolet solar cell or infrared solar cell is disposed in the central portion of the display unit front surface 601 to secure the visual, field of the user, and a rigid or flexible dye-sensitised solar cell is installed up to an area corresponding to the electric power for the system operation among the peripheral portion of the display unit front surface 601, the side surface frame upper portion 602, the side surface frame lower portion 603, the side surface frame left portion 604, the side surface frame right portion 605, the side surface frame center 606, the front surface frame upper portion 607, the front surface frame lower portion 608, the front surface frame left portion 609, the front surface frame right portion 610, the rear surface frame upper portion 611, the rear surface frame lower portion 612, the rear surface frame left portion 613, the rear surface frame right portion 614, and the rear surface frame center 615. In the remaining portion, a silicon-based solar cell may be installed for a large average power generation amount. Additionally, in the deep sleep mode (e), the clock may be fed with electric power from the ultraviolet solar cell or infrared solar cell disposed in the central portion of the display unit front surface 601.

FIG. 11 shows that the main power source of the image display device 100 is divided into a plurality of systems and a power generation element employing a different power generation method is installed for each system. In FIG. 11, in a region displayed in deep gray, represented by the reference number 1101, a dye-sensitised solar cell is installed as a first power generation element. The electric power that is generated from the dye-sensitised solar cell installed in the region 1101 is fed for the system operation that is operated continuously in the operation modes (a) to (d) in common. In a portion displayed in pale gray, represented by the reference number 1102, a silicon-based solar cell is installed as a second power generation element. The electric power that is generated from the silicon-based solar cell installed in the region 1102 is fed for an operation (an operation that is operated only in some modes) that is not in common in the operation modes (a) to (d), but is operated irregularly for each operation mode. In a portion displayed in white, represented by the reference number 1103, an ultraviolet or infrared solar cell is installed as a third power generation element. The electric power that is generated from the ultraviolet or infrared solar cell installed in the region 1103 is fed to the clock (not shown) in the deep sleep mode (e).

In FIG. 11, it is sufficiently understood that the arrangement of the respective power generation elements in the regions 1101 to 1103 is determined in consideration of the design of the image display device 100. For example, the region 1103 for power feeding to the clock, in which a transparent ultraviolet or infrared solar cell is installed, is set in the central portion of the display unit front surface 601 to perform the power generation without blocking the visual field of the user on which the image display device 100 is mounted.

### Fourth Embodiment

Next, the adaptive control of the image display device 100 for improving or maximizing the power generation amount in the power generation element unit 810 (or the amount of the power stored in the power storage unit 820) will be described as a fourth embodiment.

As described above, the power management unit 830 performs adaptive control of the power generation operation, such as control of the impedance of the power generation element unit 810 or the power storage unit 820, control of a switching operation of the power generation system (a switching operation that is performed by the switching unit 821), control of the posture of the power generation element unit 810 (control of the driving of the actuator 812 and control of the waveguide), and absorption frequency shift (in the case in which photovoltaic power generation is performed in the power generation element unit 810), according to the power generation environment and the power generation situation of the image display device 100. In addition, according to the power generation environment and the power generation situation of the image display device 100, the control unit 501 controls switching of the operation mode (described above) of the display system (the main body of the image display device 100), and controls a user's action to guide the user into a better power generation environment or power generation situation.

(1) Impedance Control

In the above-described first to third embodiments, when the power management unit 830 or the like controls the impedance of the power generation element unit 810 or the power storage unit 820, maximum power point tracking (MPPT) control (for example, see Japanese Unexamined Patent Application Publication No. 2011-181012) can be exemplified as one method. The load impedances of the power generation element 811-1, the rectification circuit unit 822, the regulator 823, and the power storage element 824 are controlled so that a current is extracted at an output voltage at which electric power that is a product of the current and the voltage from the power generation elements 811-1, . . . being used reaches a maximum.

Particularly, in the third embodiment, when only a dye-sensitised solar cell is used to supply electric power for the system operation that is in common in the operation modes (a) to (d), it is not necessary to perform the impedance control. However, when a silicon-based solar cell is used, the average power generation amount is large and a variation in power generation amount is also large, and thus the electric power system becomes nonuniform and a change is thus caused in the load impedance. Therefore, impedance control such as MPPT is preferably used.

(2) Posture Control

In the above-described first to third embodiments, when a device that performs power generation using light such as a silicon-based solar cell or a dye-sensitised solar cell is used as the power generation element 811, the power generation amount varies according to an incidence angle of light. Accordingly, it is attached via the actuator 812 so as to be movable, and is configured so that the posture of the power generation element 811 can be controlled to maximize the power generation amount typically with respect to the incidence angle of light. When the power generation element 811 is provided with an energy transfer mechanism such as a waveguide or an antenna that is equipped in the power generation element to contribute to an increase of the power generation amount, the posture of the energy transfer mechanism may be controlled using the actuator 812. The waveguide guides electromagnetic waves (including light) to the power generation element, and in addition to control of the posture of the waveguide, switching of the optical path may be performed.

FIG. 12 shows that the posture of the power generation element 811-3 installed in the rear surface frame upper portion 611, the rear surface frame lower portion 612, the rear surface frame left portion 613, the rear surface frame right portion 614, and the rear surface frame center 615 of the image display device 100 is changed by following the movement of the sun. The power generation element 811-3 is a silicon-based solar cell, for example. The power generation element 811-1 installed in the central portion of the display unit front surface 601 is an ultraviolet or infrared solar cell, and the power generation element 811-2 installed in another installation portion is a dye-sensitised solar cell.

In the example shown in FIG. 12, the posture of the power generation element 811-3 is changed so that the power generation amount becomes typically maximum with respect to the incidence angle of solar light. By changing the posture by tracking solar light as shown in FIG. 12, the power generation amount can be maximized at each solar position.

The actuator 812 can be configured by laminating, for example, a film-type piezoelectric element, a film-type magnetostrictor, an electrostatic or electromagnetic actuator, and a bimetal actuator on a rear surface of the power generation element 811 formed of a silicon-based solar cell, or a dye-sensitised solar cell. The actuator 812 may also be configured independently from the power generation element 811, rather than being laminated on the power generation element 811, and the power generation element 811 may be driven using a transmission mechanism such as wire and may be changed in posture.

(3) Operation Mode Control

In the above-described first to third embodiments, the power management unit 830 monitors the power generation amounts of the power generation elements 811-1, 811-2, 811-3, . . . (electric power, voltages, or currents output from the power generation elements), the amount of the power stored in the power storage element 824 (the voltage of the capacitor, the amount of the electric power stored in the secondary cell, and the like), and the power consumption (the amount of the electric power, voltage, or current) of the main body of the image display device 100. When receiving a report on the monitoring results from the power management unit 830, the control unit 501 adaptively switches the operation mode of the main body of the image display device 100 among the operation modes (a) to (e) to prevent the system from going down, that is caused by excessive power consumption relative to the generated electric power.

For example, as shown in FIG. 13, in the case in which an ultraviolet solar cell or an infrared solar cell is installed as a first power generation element 1301 in the central portion of the display unit front surface 601, a dye-sensitised solar cell is installed as a second power generation element 1302 in the peripheral portion of the display unit front surface 601, and a silicon-based solar cell is installed as a third power generation element 1303 in another portion, that is, in the case of a layout in which the installation area of the silicon-based solar cell occupies most of the area, the average power generation amount is increased under a power generation environment such as an outdoor location where solar light can be used. However, the power generation amount is significantly reduced under an indoor power generation environment where solar light is blocked and only indoor light can be obtained.

Therefore, it is necessary to switch the operation mode to allow the power consumption to be adapted to the power generation environment and the power generation situation.

FIG. 14 shows a flowchart showing processing procedures for switching of the operation mode of the image display device 100 by the control unit 501 according to the power generation environment and the power generation situation.

When receiving a report on the power generation environment and the power generation situation (including the power storage situation) from the power management unit 830 (Yes in Step S1401), the control unit 501 checks whether the power generation amount is sufficient in the current operation mode (whether the power consumption in the current operation mode is greater than the generated electric power) (Step S1402).

Here, when the power generation amount is not sufficient (when the power consumption in the current operation mode is greater than the generated electric power) (Yes in Step S1402), the control unit 501 predicts an operation time to operate the device, using the amount of the electric power stored in the power storage element 824 (Step S1403). The operation time mentioned herein is, for example, a time until the output voltage of the power storage element 824 is less than the voltage with which a circuit in a pre-stage of the power storage element 824, such as the regulator 823, is operated.

The control unit 501 switches the operation mode to the deep sleep mode in which the power consumption is the lowest (Step S1404), and operates a system clock only for interruption based on the voltage of the regulator 823 in the pre-stage of the power storage element 824 (Step S1405).

By virtue of the above-described processing procedures, enough electric power to perform the operation in the second energy saving mode for intermittent driving can be stored in the power storage unit 820 through switching to the deep sleep mode, even under an undesirable power generation environment in which the generated electric power is not sufficient with respect to the power consumption of the main body of the image display device 100.

In the operation mode control of the image display device 100 shown in FIG. 14, in brief, under an undesirable power generation environment, using electric power generated by the power generation element 811 for the operation of the main body of the image display device 100 is restricted for a predetermined time to make surplus power for power storage. However, in such an operation mode control, the power generation element 811 is not directly controlled, differently from the above-described impedance control and posture control.

(4) Control of Switching of Power Generation System

In the above-described first to third embodiments, the control of switching of the power generation system is based on the assumption that the plurality of kinds of power generation elements 811-1, 811-2, 811-3, . . . employing different power generation methods is used in the power generation element unit 810. When the power generation environment, changes, the power management unit 830 performs, through the switching unit 821, switching of the power generation element being used, and thus controls the power generation amount or controls electric power that is supplied to the image display device 100.

In the third embodiment, the electric power for the system operation intended to be operated at all times is fixedly fed from the power generation element that is formed of a dye-sensitised solar cell. That is, the third embodiment relates to a fixed electric power system in which allocation is previously decided for each power generation element. The electric power system fourth embodiment is a dynamic electric power system in which allocation to the respective power generation elements is dynamically switched.

For example, referring to FIG. 7, after sunset and during the night, the output of the radio wave generator using, as an electric power source, radiation electromagnetic waves from a mobile phone base station or an access point of a wireless local area network (LAN) is at its highest and is stable even after the time for lights out Meanwhile, since indoor light or outdoor light is obtained during the day, the output of the dye-sensitised solar cell and the silicon-based solar cell is increased. When the image display device 100 is disposed indoors, the power feeding may be performed using the dye-sensitised solar cell, and when the image display device 100 is disposed outdoors, the power feeding may be performed using the silicon-based solar cell.

FIG. 15 shows a flowchart showing processing procedures for switching of the power generation element that is used as a main power source by the power management unit 830 according to changes of the power generation environment.

The power management unit 830 determines whether it is night, or day (Step S1501). For example, it is possible to determine whether it is night or day by comparing a current time that is counted by a timer (not shown) built in the image display device 100 with a sunrise time and a sunset time that are obtained via the internet or the like. Otherwise, an illuminance sensor may be used to determine that it is day if it is light at the moment (even if it is not day), rather than to determine whether it is actually night or day.

Here, when it is determined that it is night (Yes in Step S1501), the power management unit 830 switches the radio wave generator as the main power source by using the switching unit 821 (Step S1502).

When it is determined that it is day (No in Step S1501), it is determined whether the image display device 100 is disposed indoors or outdoors (Step S1503). For example, it is possible to determine whether the image display device 100 is disposed indoors or outdoors based on current position information that is acquired using a GPS sensor or the like. Otherwise, irradiated light may be subjected to an analysis of its components to determine that the image display device is disposed indoors if there are a lot of indoor light components of a fluorescent lamp and the like, rather than to determine whether the image display device 100 is really disposed indoors or outdoors.

When it is determined that it is day and the image display device 100 is disposed indoors (Yes in Step S1503), the power management unit 830 switches the dye-sensitised solar cell as the main power source by using the switching unit 821 (Step S1504). In addition, when it is determined that it is day and the image display device 100 is disposed outdoors (No in Step S1503), the power management unit 830 switches the silicon-based solar cell as the main power source by using the switching unit 821 (Step S1505).

Without using the processing procedures shown in FIG. 15, a method of comparing the current power generation amounts of the respective power generation elements to feed power with simple switching to a power generation element having the largest power generation amount may be used.

(5) Control of User's Action

In the above-described (1) to (4), the control unit 501 or the power management unit 830 performs direct control in the image display device 100 to improve or maximize the power generation amount of the power generation element unit 810 or the amount of the power stored in the power storage unit 820. In the control of a user's action of (5), the control target is the user, so to speak, and this control is intended to guide the user into a better power generation environment or a better power generation situation.

To put it most simply, the control unit 501 displays information related to the current power generation situation or power storage situation received from the power management unit 830 on the display unit 509. For example, information related to a residual capacity (that is expressed by % or as a converted value of operable time) of the power storage element 824 in the power storage unit 820 and an operable time that is guessed from the residual capacity of the power storage element 824 and the current power generation amount in the power generation element unit 810 is displayed on the display unit 509 to increase affordance related to the power generation. The information may be displayed in the form of a character string or an image including an icon representing the residual capacity or time.

To more highly control a user's action, a method of guiding the user to allow the user to take an action to improve or maximize the power generation amount in the power generation element unit 810 is considered.

FIG. 16 schematically shows a functional configuration adapted to control a user's action by the image display device 100 to improve or maximize the power generation amount in the power generation element unit 810.

The state detection unit 504 acquires information of a current position and a current posture as a current state of the image display device 100 or the user on which the image display device 100 is mounted, and outputs the information to the control unit 501. In addition, the environmental sensor 516 detects an environmental factor such as electromagnetic waves (light or ultraviolet rays) to which the image display device 100 is exposed, and outputs the detected information to the control unit 501.

The power management unit 830 acquires information related to the power generation situation such as the power generation amounts of the power generation elements installed in the installation portions 601 to 615, and outputs the information to the control unit 501.

The control unit 501 analyzes the information of the user's state acquired from the state detection unit 504, the environmental factor detected by the environmental sensor 516, and the power generation situation acquired from the power management unit 830. For example, a strength distribution of the environmental factor in the surrounding environment of the image display device 100 or the user on which the image display device 100 is mounted is taken based on the user's position or posture at the time of acquiring the power generation situation. For example, when the power generation is performed using light such as ultraviolet rays, based on ultraviolet intensities in a plurality of states that are different in terms of the position or posture, a direction of a light source is specified, or to which position to move and in which direction to go in order to increase the intensity of the ultraviolet rays that are applied are understood.

Next, based on the analysis results, the control unit 501 generates guidance information for guiding the user into a state for increasing the amount of the ultraviolet rays that are irradiated onto the image display device 100, in other words, the power generation amount.

The control unit 501 displays the generated guidance information on the screen of the display unit 509. The control unit 501 may output the guidance information as a voice from the voice input/output unit 514 in place of or with the display on the screen.

FIG. 17 shows that the display unit 509 displays guidance information 1702 in a superimposed manner on an image 1701 of the visual field of the user that is displayed in a see through manner. In the example shown in FIG. 17, the amount of ultraviolet rays that are used in the power generation is acquired, and the guidance information 1702 for showing a direction in which the user has to move to increase the ultraviolet rays that are applied is displayed as a sub-screen of the display unit 509.

For example, when the state information acquisition unit 504 detects that the user moves to the right based on the output information of the acceleration sensor, the environmental information acquisition unit 516 acquires information of the amount of ultraviolet rays at that time. Next, when the movement of the user to the left is detected, the environmental information acquisition unit 516 acquires information of the amount, of ultraviolet rays at that time.

The control unit 501 compares the ultraviolet level at which the user moves to the right with the ultraviolet level at which the use moves to the left. Here, when the amount of ultraviolet rays detected when the user moves to the right is larger, the guidance information 1702 that is used to show the fact that when the user moves to the right, the exposure to ultraviolet rays is increased, and thus the power generation amount is increased and the operation time of the image display device 100 is also increased, that is, to promote a rightward movement or issue an alert is displayed as a sub-screen with respect to the original display screen (main screen) 1701, as shown in FIG. 17. By virtue of the display of the guidance information 1702, an increase in affordance related to the power generation is expected.

(6) Frequency Matching

In the above-described first to third embodiments, power generation elements employing different power generation methods such as a silicon-based solar cell, a dye-sensitised solar cell, and an ultraviolet or infrared solar cell are properly used and installed in the respective installation portions 601 to 615, and basically, the power generation is assumed to be performed using light having different frequency components for each power generation method.

In this embodiment, a frequency conversion unit is attached to irradiation surfaces of at least some power generation elements employing different power generation systems so that the same power generation element performs the power generation even with a plurality of frequency components through absorption frequency shift. In the absorption frequency-shifted frequency band, the number of the power generation elements capable of performing the power generation in the power generation element unit 810 is increased, and thus the power generation amount is increased.

FIG. 18 illustrates a functional configuration of the electric power system of the image display device 100 adopting absorption frequency shift.

In the example shown in FIG. 18, a power generation element unit 1810 includes a power generation element 1811-1 that performs power generation using a first frequency band, a power generation element 1811-2 that performs power generation using a second frequency band, and a power generation element 1811-3 that performs power generation using a third frequency band.

In pre-stages of the irradiation surfaces of the power generation elements 1811-1, 1811-2, and 1811-3, frequency conversion units 1813-1, 1813-2, and 1813-3 are respectively disposed as auxiliary power generation mechanisms that optimize the frequency of arrived electromagnetic waves. The frequency conversion unit 1813-1 converts a light component in the second or third frequency band into a light component in the first frequency band. Similarly, the frequency conversion unit 1813-2 converts a light component in the first or third frequency band into a light component in the second frequency band, and the frequency conversion unit 1813-3 converts a light component in the first or second frequency band into a light component in the third frequency band.

The environmental sensor 516 detects a frequency band of electromagnetic waves that are irradiated onto the power generation elements 1811-1, 1811-2, and 1811-3. Based on the detection results of the environmental sensor 516, the power management unit 830 performs frequency matching using the frequency conversion units 1813-1, 1813-2, and 1813-3 so that the applied electromagnetic waves become optimum for the power generation elements 1811-1, 1811-2, and 1811-3 (so that the power generation amount is increased or maximized). For example, when electromagnetic waves in the first frequency band are applied, the power management unit 830 performs control to convert the frequency band of the electromagnetic waves into the second frequency band and the third frequency band using the frequency conversion units 1813-2 and 1813-3.

The power management unit 830 adaptively performs frequency matching with changes of the power generation environment such as passage of time during a single day and whether the device is disposed indoors or outdoors, and thus the power generation amount of the power generation element unit 1810 can be increased or maximized for each power generation environment.

As the frequency conversion units 1813-1, 1813-2, and 1813-3, for example, a wavelength conversion element using photonic crystal that has a refractive index that varies periodically and blocks a specific wavelength can be used (for example, see Japanese Unexamined Patent Application Publication. No. 2011-164127). When using slab photonic crystal in which micropores are regularly formed on a thin plate, frequency conversion can be realized by dynamically changing the micropores or by switching a member having a different pore diameter. The configuration of the frequency conversion unit that can be applied to this embodiment is not limited thereto.

(7) Exchange of Power Generation Element

The image display device 100 according to this embodiment can use power generation elements of a plurality of power generation methods, and can arbitrarily determine combinations of the power generation elements with the installation portions 601 to 615. The power generation element that is installed in each of the installation portions 601 to 615 may be configured as a replacement component that is replaceable in the main body of the image display device 100. In such a case, every time the user uses the image display device 100, the combinations of the power generation elements with the installation portions 601 to 615 can be optimally changed according to the power generation environment at that time.

In the above-described (1) to (6), based on the fact that the determined combinations of the power generation elements with the installation portions 601 to 615 are fixed, the power generation amount in the power generation element unit 810 is improved or maximized by impedance control, control of switching of the power generation system, frequency matching, and the like. (7) is different in that the power generation amount is improved or maximized by changing the combinations of the power generation elements with the installation portions 601 to 615.

In addition, in the above-described (1) to (6), the power generation amount is improved or maximized by control of the control unit 501 and the power management unit 830 in the image display device 100. (7) is different from the viewpoint of the fact that the power generation amount is improved or maximized through a user's manual operation, i.e., component replacement.

As a form for realizing the replacement, of the power generation element, a structure that is replaceable as an eyeglass lens and in which any one power generation element is selectively attached is exemplified for the display unit front surface 601. The user may replace an ultraviolet solar cell or an infrared solar cell through which visible light is transmitted with a semitransparent dye-sensitised solar cell according to the power generation environment and the use environment. For example, under a use environment in which there is no moving object or obstacle in a sufficiently bright room, safety is secured and an increase in the power generation amount is expected even when a semitransparent power generation element is installed in the visual field of the user.

In addition, as another form for realizing the replacement of the power generation element, a structure in which a plurality of power generation elements is installed in a superimposed manner in one installation portion is exemplified. The user may detach power generation elements that are not used, and may keep only power generation elements that are used in the installation portion, to obtain a necessary and sufficient power generation amount and keep transparency of the installation portion and the whole design of the image display device 100.

The position of a power generation element configured to be replaceable is not limited to one location, i.e., the display unit front surface 601. It can also be applied to other installation portions 602 to 615.

### Fifth Embodiment

The first to fourth embodiments are configured so that the power generation is performed using solar light, interior lighting, and electromagnetic waves arriving from the outside, such as radio waves emitted from a base station, as a main energy source.

In a fifth embodiment, the display panels 104L and 104R (or the display panels 304L and 304R) in the display unit 509 perform power generation using, as an energy source, light that is used in the image display.

For example, in the case of the transmission-type image display device 100, a configuration in which an insertion-type power generation element formed of a photocell or the like is installed in the polarizing filter (described above) that reflects light propagated inside the light guide plates of the virtual image optical units 101L and 101R is considered.

In addition, in both of the transmission-type image display device 100 and the immersion-type image display device 300, a configuration in which an insertion-type power generation element formed of a photocell or the like is installed in the color filter (described above) that is used for colorization or for improving color purity of the display panel (an organic EL display or the like) of the display unit 509 (for example, see Japanese Patent No. 4019496) is considered.

In the first to fourth embodiments, the power generation element is externally fitted to the outer surface of the main body of the image display device 100 (or 300). The fifth embodiment is different in that the power generation element that is used in the fifth embodiment is an insertion type.

FIG. 19 schematically shows a cross-section structure of the display panel provided with a power generation element. In FIG. 19, the reference number 1901 represents a surface protection layer or a polarizing layer. The reference number 1902 represents a power generation element layer that is inserted to perform the power generation using solar light, ultraviolet rays, infrared rays, and various electromagnetic waves such as radio waves. The reference number 1903 represents a display panel layer such as an organic EL display or a liquid crystal display. The display panel layer 1903 may include a display drive circuit and other circuits. The display panel layer 1903 may further include a power storage element (a secondary cell, a capacitor, or the like) that stores power using electric power generated from the power generation element layer 1902.

During the use of the image display device 100 (or 300) (when the display unit 509 performs display), the power generation element inserted in the polarizing filter or the color filter as described above performs the power generation using, as an energy source, light that is used in the image display of the display unit 509. During when the image display device 100 (or 300) is not mounted on the user and is not used (when the display unit 509 does not perform display), the power generation can be performed using, as a main energy source, electromagnetic waves arriving from the outside, as in the case of the external fitting-type power generation element in the first to fourth embodiments.

When a photocell having a sensitivity specialized to meet the power generation environment during when the display is not carried out is applied as the insertion-type power generation element, the power generation efficiency is improved. For example, when the image display device 100 is used outdoors, a photocell having a sensitivity in a wide range including ultraviolet rays, visible light, and infrared rays is preferably used. When the image display device 100 is used indoors, a photocell having a sensitivity only to visible light may be used.

### Sixth Embodiment

A power generation element also having a sensitivity to infrared side as in the case of a dye-sensitised solar cell has a sensing function, as well as a power generation function. Accordingly, a power generation element having a sensitivity to infrared side, that is installed in any of the installation portions 601 to 615, may also be used in sensing as in the case of a motion sensor and the like in a dark location. For example, the control unit 501 or the power management unit 830 can perform sensing based on the voltage or current output from such a power generation element, or a power generation amount. The image display device 100 in which a photocell having a sensitivity to infrared side is installed can be configured as a head-mounted display with an infrared camera attached thereto.

In the first to fifth embodiments, the power generation element is used only in the power generation. The sixth embodiment is different in that the power generation element provides a function other than power generation, such as sensing.

Although the present technology has been described in the form of exemplification, the content disclosed in this specification should not be limitedly understood. In order to determine the gist of the present technology, claims should be referred to.

The present technology can also employ the following configurations:

(1) An image display device including an image display unit that displays an image, a mounting unit that is adapted to mount the image display unit on a user's head or face, a power generation element that is attached to one or more installation portions including an outer surface of the image display unit or the mounting unit, and a control unit that performs control based on a power generation amount of the power generation element.

(2) The image display device according to (1), in which the power generation element is at least one of a silicon-based solar cell, a CdTe-based solar cell, a dye-sensitised solar cell, an iron sulfide-based solar cell, an ultraviolet solar cell, an infrared solar cell, an element (radio wave generation (using a distant electromagnetic field)) that induces electric power using at least one of electromagnetic induction and electrostatic induction with radio waves (a distant electromagnetic field) or a near electromagnetic field, power generation using a near electromagnetic field, and a wireless power feeding element (including a magnetic resonance type, an electromagnetic induction type, and an electric field coupling type).

(3) The image display device according to (1), in which the image display unit displays the image in a see through manner, and a transparent first power generation element is installed at the center of the outer surface of the image display unit.

(4) The image display device according to (3), in which a semitransparent second power generation element is installed in a peripheral portion of the outer surface of the image display unit.

(5) The image display device according to (4), in which a flexible third power generation element is installed in an installation portion other than the image display unit.

(6) The image display device according to (5), in which the first power generation element is an ultraviolet or infrared solar cell, the second power generation element is a dye-sensitised solar cell, and the third power generation element is a silicon-based solar cell.

(7) The image display device according to (5), in which the first power generation element is an ultraviolet or infrared, solar cell, the second power generation element is a rigid dye-sensitised solar cell, and the third power generation element is a flexible dye-sensitised solar cell.

(8) The image display device according to (1), in which the image display device can be operated in a plurality of operation modes different in power consumption, and further includes a plurality of power generation elements employing different power generation methods corresponding to the power consumptions in the respective operation modes.

(9) The image display device according to (8), in which a first power generation element that is used to feed power for a system operation that is operated at all times in all of the operation modes, a second power generation element that is used to feed power for an operation that is operated only in some modes, and a third power generation element that is used to feed power for a clock are provided.

(10) The image display device according to (9), in which the first power generation element is a dye-sensitised solar cell, the second power generation element is a silicon-based solar cell, and the third power generation element is an ultraviolet or infrared solar cell.

(11) The image display device according to (1), in which the control unit performs adaptive control to increase or maximize the power generation amount of the power generation element.

(12) The image display device according to (11), in which a plurality of power generation elements employing different power generation methods is provided, and the control unit controls impedances of the plurality of power generation elements.

(13) The image display device according to (12), in which the control unit performs maximum power point tracking (MPPT) control so that a current is extracted at an output voltage at which electric power from the plurality of power generation elements reaches a maximum.

(14) The image display device according to (11), in which a power generation element that performs power generation using electromagnetic waves is provided, the image display device further includes an actuator that changes a posture of the power generation element or an energy transfer mechanism such as a waveguide or an antenna that is equipped in the power generation element to contribute to an increase of the power generation amount, and the control unit controls the posture of the power generation element or the energy transfer mechanism using the actuator so that the power generation amount becomes typically maximum with respect to an incidence angle of electromagnetic waves.

(15) The image display device according to (11), in which the image display device can be operated in a plurality of operation modes different in power consumption, and the control unit switches the operation mode of the image display device according to the power generation amount of the power generation element.

(16) The image display device according to (11), in which a plurality of power generation elements employing different power generation methods is provided, and the control unit feeds power by switching the power generation element according to a change in the power generation amount.

(17) The image display device according to (11), in which the control unit performs guidance into a user's action in which the power generation amount of the power generation element is increased or maximized.

(18) The image display device according to (17), in which the control unit allows an image showing a user's movement direction for increasing or maximizing the power generation amount of the power generation element to be displayed on the image display unit.

(19) The image display device according to (11), in which a power generation element that performs power generation using electromagnetic waves of a specific frequency is provided, the image display device further includes a frequency conversion unit that converts the frequency of the electromagnetic waves arriving at the power generation element, and the control, unit controls the conversion of the frequency by the frequency conversion unit to increase or maximize the power generation amount of the power generation element.

(20) The image display device according to (11), in which a plurality of power generation elements employing different power generation methods is replaceably installed in one installation portion.

(21) The image display device according to (11), in which a plurality of power generation elements employing different power generation methods is detachably installed in a superimposed manner in one installation portion.

(22) The image display device according to (1), further including a power generation element that performs power generation using display light of the image display unit.

(23) The image display device according to (22), in which the image display unit includes a light guide plate that propagates the display light and a polarizing filter that reflects the display light inside the light guide plate, and the power generation element is inserted in the polarizing filter.

(24) The image display device according to (22), in which the image display unit includes a color filter that colorizes a display image or improves color purity, and the power generation element is inserted in the color filter.

(25) The image display device according to (22), in which the image display unit includes a power generation element doubling as a color filter that colorizes a display image or improves color purity.

(26) The image display device according to (1), in which the control unit performs sensing based on the output of the power generation element.

(27) The image display device according to (1), in which the power generation element is formed of a photocell having a sensitivity to visible light and infrared side, and the control unit performs motion sensing based on the output on the infrared side of the power generation element.

(28) An image display method including detecting a power generation amount of a power generation element that is installed in at least one of an image display unit or a mounting unit that is adapted to mount the image display unit on a user's head or face, and controlling the image display device provided with the image display unit, based on the power generation amount.

It should be understood by those skilled in the art that various modifications, combinations, sub-combinations and alterations may occur depending on design requirements and other factors insofar as they are within the scope of the appended claims or the equivalents thereof.

What is claimed is:

1. An image display device comprising:
an image display unit that displays an image;
a mounting unit that is adapted to mount the image display unit on a user's head or face;
a power generation element that is attached to one or more installation portions including an outer surface of the image display unit or the mounting unit; and
a control unit that performs control based on a power generation amount of the power generation element.

2. The image display device according to claim 1,
wherein the power generation element is at least one of a silicon-based solar cell, a CdTe-based solar cell, a dye-sensitised solar cell, an iron sulfide-based solar cell, an ultraviolet solar cell, an infrared solar cell, an element (radio wave generation (using a distant electromagnetic field)) that induces electric power using at least one of electromagnetic induction and electrostatic induction with radio waves (a distant electromagnetic field) or a near electromagnetic field, power generation using a near electromagnetic field, and a wireless power feeding element (including a magnetic resonance type, an electromagnetic induction type, and an electric field coupling type).

3. The image display device according to claim 1,
wherein the image display unit displays the image in a see through manner, and
wherein a transparent first power generation element is installed at the center of the outer surface of the image display unit.

4. The image display device according to claim 3,
wherein a semitransparent second power generation element is installed in a peripheral portion of the outer surface of the image display unit.

5. The image display device according to claim 4,
wherein a flexible third power generation element is installed in an installation portion other than the image display unit.

6. The image display device according to claim 5,
wherein the first power generation element is an ultraviolet or infrared solar cell, the second power generation element is a dye-sensitised solar cell, and the third power generation element is a silicon-based solar cell.

7. The image display device according to claim 5,
wherein the first power generation element is an ultraviolet or infrared solar cell, the second power generation element is a rigid dye-sensitised solar cell, and the third power generation element is a flexible dye-sensitised solar cell.

8. The image display device according to claim 1,
wherein the image display device can be operated in a plurality of operation modes different in power consumption, and further comprises a plurality of power generation elements employing different power generation methods corresponding to the power consumptions in the respective operation modes.

9. The image display device according to claim 8,
wherein a first power generation element that is used to feed power for a system operation that is operated at all times in all of the operation modes, a second power generation element that is used to feed power for an operation that is operated only in some modes, and a third power generation element that is used to feed power for a clock are provided.

10. The image display device according to claim 9,
wherein the first power generation element is a dye-sensitised solar cell, the second power generation element is a silicon-based solar cell, and the third power generation element is an ultraviolet or infrared solar cell.

11. The image display device according to claim 1,
wherein the control unit performs adaptive control to increase or maximize the power generation amount of the power generation element.

12. The image display device according to claim 11,
wherein a plurality of power generation elements employing different power generation methods is provided, and
wherein the control unit controls impedances of the plurality of power generation elements.

13. The image display device according to claim 12,
wherein the control unit performs maximum power point tracking (MPPT) control so that a current is extracted at an output voltage at which electric power from the plurality of power generation elements reaches a maximum.

14. The image display device according to claim 11,
wherein a power generation element that performs power generation using electromagnetic waves is provided,
wherein the image display device further comprises an actuator that changes a posture of the power generation element or an energy transfer mechanism such as a waveguide or an antenna that is equipped in the power generation element to contribute to an increase of the power generation amount, and
wherein the control unit controls the posture of the power generation element or the energy transfer mechanism using the actuator so that the power generation amount becomes typically maximum with respect to an incidence angle of electromagnetic waves.

15. The image display device according to claim 11,
wherein the image display device can be operated in a plurality of operation modes different in power consumption, and
wherein the control unit switches the operation mode of the image display device according to the power generation amount of the power generation element.

16. The image display device according to claim 11,
wherein a plurality of power generation elements employing different power generation methods is provided, and
wherein the control unit feeds power by switching the power generation element according to a change in the power generation amount.

17. The image display device according to claim 11,
wherein the control unit performs guidance into a user's action in which the power generation amount of the power generation element is increased or maximized.

18. The image display device according to claim 17,
wherein the control unit allows an image showing a user's movement direction for increasing or maximizing the power generation amount of the power generation element to be displayed on the image display unit.

19. The image display device according to claim 11,
wherein a power generation element that performs power generation using electromagnetic waves of a specific frequency is provided,
wherein the image display device further comprises a frequency conversion unit that converts the frequency of the electromagnetic waves arriving at the power generation element; and
wherein the control unit controls the conversion of the frequency by the frequency conversion unit to increase or maximize the power generation amount of the power generation element.

20. The image display device according to claim 11,
wherein a plurality of power generation elements employing different power generation methods is replaceably installed in one installation portion.

21. The image display device according to claim 11,
wherein a plurality of power generation elements employing different power generation methods is detachably installed in a superimposed manner in one installation portion.

22. The image display device according to claim 1, further comprising:
a power generation element that performs power generation using display light of the image display unit.

23. The image display device according to claim 22,
wherein the image display unit includes a light guide plate that propagates the display light and a polarizing filter that reflects the display light inside the light guide plate, and
wherein the power generation element is inserted in the polarizing filter.

24. The image display device according to claim 22,
wherein the image display unit includes a color filter that colorizes a display image or improves color purity, and
wherein the power generation element is inserted in the color filter.

25. The image display device according to claim 22,
wherein the image display unit includes a power generation element doubling as a color filter that colorizes a display image or improves color purity.

26. The image display device according to claim 1,
wherein the control unit performs sensing based on the output of the power generation element.

27. The image display device according to claim 1,
wherein the power generation element is formed of a photocell having a sensitivity to visible light and infrared side, and
wherein the control unit performs motion sensing based on the output on the infrared side of the power generation element.

28. An image display method comprising:
detecting a power generation amount of a power generation element that is installed in at least one of an image display unit or a mounting unit that is adapted to mount the image display unit on a user's head or face; and
controlling the image display device provided with the image display unit, based on the power generation amount.
